(19) United States
(12) Patent Application Publication
(10) Pub. No.: US 2010/0042682 A1
(43) Pub. Date: Feb. 18, 2010

(54) Digital Rights Management for Music Video Soundtracks

(76) Inventor: Evan John Kaye, Short Hills, NJ (US)

Correspondence Address: EVAN J. KAYE, 330 White Oak Ridge Rd, Short Hills, NJ, 07078, US

(21) Appl. No.: 12/541,900

(22) Filed: Aug. 14, 2009

Related U.S. Application Data
(60) Provisional application No. 61/089,323, filed on Aug. 15, 2008.

(51) Int. Cl. G06F 15/16

(52) U.S. Cl. 709/203

(57) ABSTRACT

The present invention relates to a mechanism for sharing user generated music videos in an online community. User generated visual content that can be synchronized with a soundtrack is shared independent of the soundtrack. In this way the copyrighted material is not shared and digital rights can be respected and enforced. Members of the online community that own the soundtrack can view the shared visual content automatically synchronized to the soundtrack they are listening to on their local machine.

### FIELD OF THE INVENTION

The present invention relates to a mechanism for sharing user generated music videos in an online community. User generated visual content that can be synchronized with a soundtrack is shared independent of the soundtrack. In this way the copyrighted material is not shared and digital rights can be respected and enforced. Members of the online community that own the soundtrack can view the shared visual content automatically synchronized to the soundtrack they are listening to on their local machine.

### BACKGROUND OF THE INVENTION

User-generated video content shared online has become popular recently as broadband connections have become more ubiquitous. One type of video that is commonly produced is a home-made music video. In the case of such a video, a soundtrack is oftentimes used that is under copyright protection, and users generate a spoof or some other entertaining video to accompany the soundtrack. Given the enormous quantity of soundtracks inherently bundled with the generated music video and distributed illegally in this manner, it has become a substantial problem to enforce the copyrighted content.

Some audio file formats have the applicable digital rights management (DRM) features that will not allow the audio content to be included in a video file. In this way, the copyrighted content is protected but the user is unable to create a music video using the soundtrack.

Furthermore, many people purchase soundtracks online nowadays (for example, through Apple Corporation's iTunes service) and may have a licensed copy of the soundtrack on their local machine. But currently there is no mechanism for people with licensed copies of soundtracks on their local machine to listen to their licensed copy while watching visual user-generated content that is automatically selected and synchronized to the audio content they are listening to.

Another problem with music videos streamed from a server, especially user-generated music videos, is that the audio quality is compromised because of the nature of the compression, or the way the content was produced.

Many find music videos entertaining because it adds another dimension to the soundtracks people listen to. When listening to music on a local machine, the only way to currently supplement the soundtracks that are listened to are by means of “visualizers”. Visualizers are programs that generate visual effects based on the current sounds being played by the local machine.

At nightclubs, bars and any other venues where disk-jockeys play and mix soundtracks, there is a paucity of ways that exist for such disk-jockeys to supplement the music they play with visual content—even though there is a lot of visual content that exists tied to the soundtracks they are playing. Sometimes they may play a music video on screens, but oftentimes there is nothing but the music. Given the ubiquity of low cost projection systems, and flat-screen panels, it would be welcomed entertainment to tie specific visual content to soundtracks being played, and show user-generated music video clips tied to the audio content, but no current mechanism exists for this.

When users generate their own video content, they generally play the soundtrack and record visual content using a webcam or video-camera, the content of which is later downloaded to their local machine. The audio quality is generally poor in these types of amateur recordings. If the user is more sophisticated and is able to overlay various scenes shot at different times on a soundtrack using video editing equipment, the quality of the sound is better but they oftentimes are not able to perfectly match the music to the actions in the video compromising the synchronicity between mouth movements on the video, and voices heard on the soundtrack. Professional music videos are made using a clapboard or similar mechanism, which is usually not available to the amateur video maker. What is needed is a simple mechanism for users to generate tightly synchronized video content with audio soundtracks, and have the ability to edit scenes without disrupting the underlying audio content.

### SUMMARY OF THE INVENTION

What is needed in the art is a mechanism for users to generate video content tied to specific audio soundtracks and share them with other users who can, in turn, tie the shared video content back to local copies of the original soundtrack that the receiving user has purchased, and view the combined results as a music video.

In one aspect of the invention, an easy mechanism for a first user to produce video content synchronized with a soundtrack is provided. This video content can be an edited series of scenes that are all synchronized with the soundtrack. The user can then post only the video content and timestamp information to a community where others can download it. An alternative mechanism is provided for recording video content through a web camera, whereby timestamp information is derived directly from the current song being played on the local machine.

In a related aspect of the invention, there is a component that is installed on the recipient machine that monitors which songs are being played by the user. When a song is played that has corresponding video content in the communal library, then the user is notified and can choose whether they wish to view the music video. There is no interruption of the song being played, the video content synchronizes with the part of the song that is currently playing, even if the user changes positions on the track. Sometimes there may be multiple videos available for a given soundtrack, in which case a mechanism is provided for the user to switch through the videos, or view multiple videos on the screen simultaneously.

In a further aspect of the invention, a mechanism is provided for a user to explore the library of online video content. If a user wishes to watch a music video but does not have the corresponding soundtrack on their local machine, they can view the video content without hearing the sound. Depending on the permissions given by the copyright holder of the soundtrack, they may be able to listen to a sample segment of the soundtrack (as commonly done on the iTunes service), in which case the video content for that segment would be displayed while the user listens to it. There is also a mechanism for the user to purchase the soundtrack directly from the website. This will download a local copy to their machine, and it will then be possible to view the entire video.

Sometimes there are numerous versions of the same song in which the timestamp information differs slightly. There is a mechanism for the original user or any other user to synchronize the video to the new soundtrack if they are not exactly synchronized. A manual means of fine tuning the synchronization can, for instance, be provided by a control on the screen that is manipulated by mouse or keyboard.

### DESCRIPTION OF THE FIGURES

FIG. 1 illustrates a network arrangement of hardware for implementing a method in accordance with a preferred embodiment of the invention;

FIG. 2 shows a schematic illustration of the flow of video content within the network;

FIG. 3 shows a flowchart of how the installed application works with the browser to synchronize the video content with the local audio content;

FIG. 4 shows a download web page that is used to download an application to the client machine to facilitate the recording and playing of synchronized video content;

FIG. 5 shows a web page that is used to browse videos that have been shared by users in an online community;

FIG. 6 shows a web page that is used to play videos that have been shared by users in an online community;

FIG. 7 shows a web page that is used to record and share videos with an online community;

FIG. 8 shows a web page that is used to display the connection status with a music player.

### DETAILED DESCRIPTION OF THE PREFERRED EMBODIMENT

The invention is described in detail with particular reference to a certain preferred embodiment, but within the spirit and scope of the invention, it is not limited to such an embodiment. It will be apparent to those of skill in the art that various features, variations, and modifications can be included or excluded, within the limits defined by the claims and the requirements of a particular use.

The preferred embodiment of the invention is an online community where members can share user generated video content with each other. The videos that are available for users to watch contain metadata that allow them to be synchronized to soundtracks that the user has on their local machine. For instance, a track name, artist name and track size are used to identify the music track that the video is related to. The music track time (in seconds) where the video should start playing is also part of the video metadata. The methods, algorithms and web pages described below provide a framework for allowing users to easily contribute video content to such an online video repository with the appropriate metadata automatically generated. Furthermore, it provides a framework for consumers of the video information to automatically have relevant video content selected and synchronized with the music track they are playing on their local machine at the time they view a play web page. The preferred embodiment can best be described by way of the accompanying drawings.

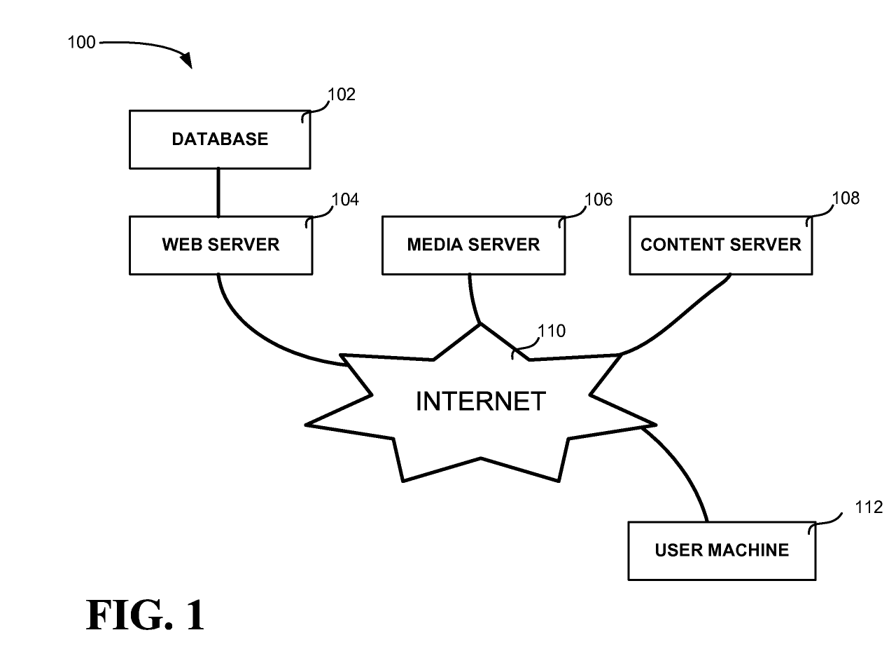

With reference to FIG. 1, a network arrangement of hardware 100 for implementing a method in accordance with a preferred embodiment of the invention is shown. A web server 104 with its database 102 is connected to the Internet 110 and is responsible for generating the web pages that are used on the web site. A media server 106 which is responsible for accepting encoded video streams, saving them to disk as a video file, transcoding the video file into another format, uploading the resulting video file to a content server 108, and communicating the status of all content to the web server 104 through the use of web service interfaces so that the status of each video file can be kept in the database 102. The user machine 112 is also connected to the Internet 110 through which it communicates with the web server 104, media server 106 and content server 108.

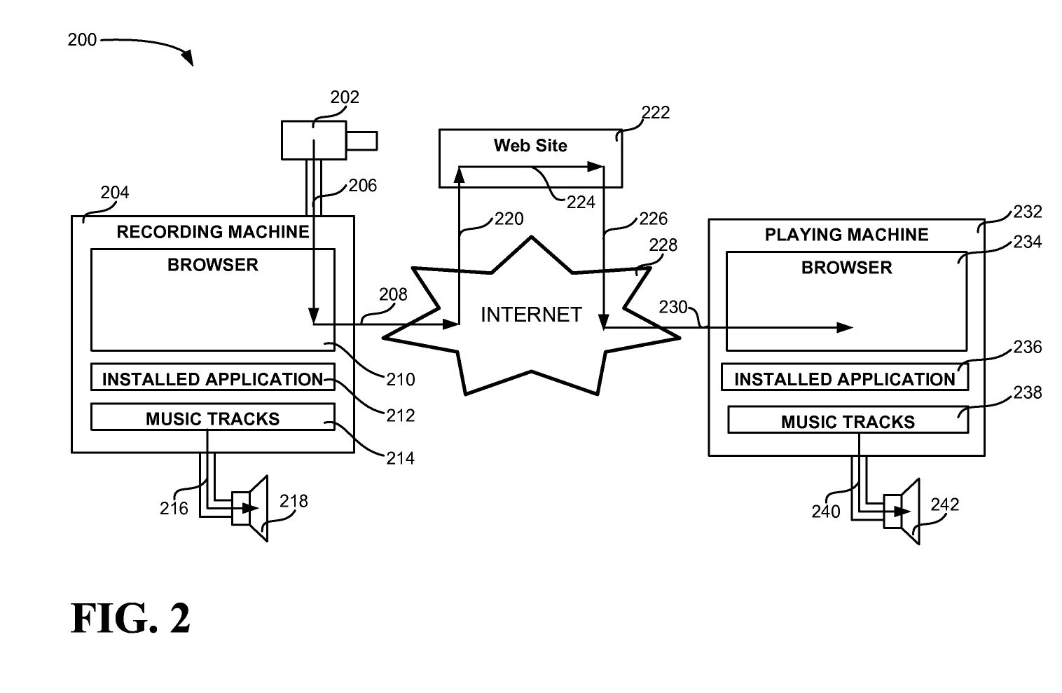

With reference now to FIG. 2, a schematic 200 illustrates the flow of video and audio content through the system. The recording machine 204, with its browser 210 and installed application 212 communicates through the Internet 228 with the web site 222. The playing machine 232 with its browser 234 and installed application 236 also communicates with the web site 222 via the Internet 228. The recording machine 204 has a video input device 202 attached to it, through which video content 206 is captured, encoded in the browser, and then sent 208 to through the Internet 228 to the web site 222 which receives 220 the encoded video content. The installed application 212 serves the support role of providing the current position of the audio track when the recording is started. As it is preferable to start recording at the time the second changes on the audio track, and not in between, the installed application 212, which send a command to the browser 210 every time the time (as measured in seconds) changes also triggers the actual recording to start when the recording script in the browser 210, or in an embedded component within the browser (for example, an ActiveX component like Flash Media Player), is in a prerecord mode. Thus the user clicking the record button does not cause the recording to start immediately but rather causes the script to enter a prerecord mode which will change to a record mode when the next time command is sent from the installed application 212 to the script via scripting on the web page. The music tracks 214 that are on the machine's local disk (or the machine has access to on its own local area network) is not transmitted to the web site 222, but is instead played 216 directly on a locally attached speaker 218. The playing machine 232 plays 240 music tracks 238 that are on the local machine (or the machine has access to on its own local area network) through locally attached speakers 242, and video content is sent 226 from the web site 222 via the Internet 228 and downloaded 230 into the playing machine 232 browser 234 to match the music tracks 238 that play 240 on the playing machine 232. The installed application 236 detects the attributes of the music tracks 238 that are playing 240 via the music player's application programming interface and sends this identifying information to the web site 222 which will determine if there are any videos that match the track that is playing on the playing machine 232. If there are matches, then details of the matches are sent back to the playing machine's browser 234 and the user can select which video they would like to be synchronized to the music track they are listening to. Using this methodology the video content is shared 224 within the community but the associated music tracks are not disseminated and stay on the local machines.

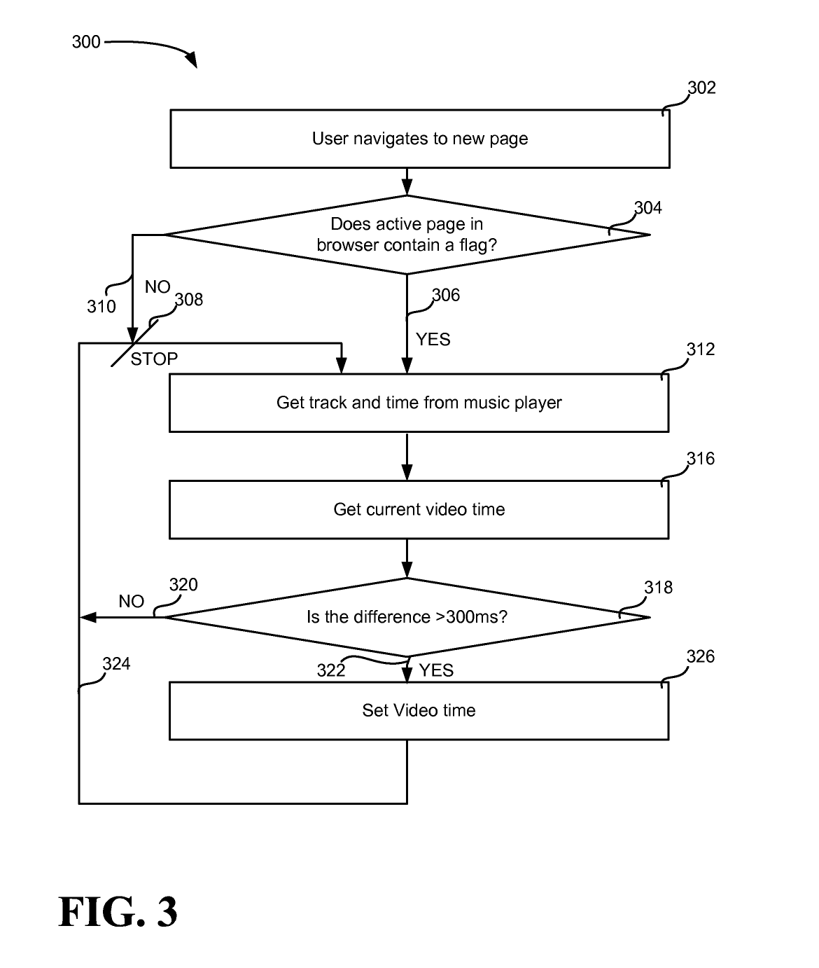

With reference now to FIG. 3, a flowchart 300 of how the installed application works with the browser to synchronize the video content with the local audio content is shown. At step 302 the user navigates to a new web page in the browser, the installed application then evaluates whether the active page in the browser contains a flag at step 304. The flag may be some specific wording in the url of the web page, or within the web page text. Another identifying characteristic of the web page may be a script that automatically executes from the page to initiate an interaction with the installed application. If the web page does contain flag 306 then the installed application enters a recurring loop 324 that it implements a set time interval (e.g. 3 second interval). At step 312 the installed application gets the track and time from the music player relating to the active track that is playing. The installed application then gets the current video time at 316 from the browser of the exact frame that is currently playing of the video content. At step 318 it compares the time of the music track to the time of the video (adjusting for factors such as if the video segment playing had a start time that was greater than 0 seconds, or if the music track playing was actually a preview of the original music track and had a start time of greater than 0 seconds, or if the user had used a means to fine tune the synchronization by providing some input through a visual component displayed in the web browser as to the number of milliseconds that the synchronization should be adjusted in either direction). If the difference is higher than a threshold duration which is discernable by a human viewer (e.g. 300 ms) then it proceeds 322 to step 326 where it send a command via the browser to the video player to seek to a frame in the video that matches the time of the music playing in the music player. Returning to step 304 if the active page in the browser does not contain a flag then it proceeds 310 to stop 308 the recurring loop from operating in the installed application.

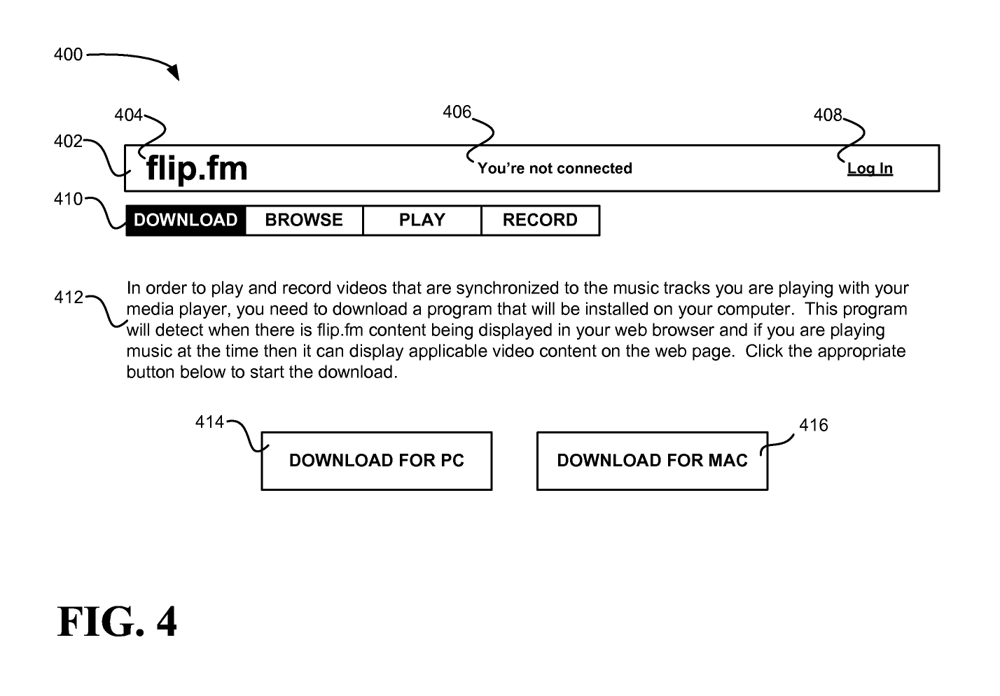

With reference now to FIG. 4, an exemplary download web page 400 is shown that is used to download an application to the client machine to facilitate the recording and playing of synchronized video content. The header section 402 contains the name of the web site 404, as well as the connection status 406 and the login status 408. The connection status 406 indicates that the user is “not connected”, which means that there is at present no communication between the page in the web browser and the music player on the local machine. Such communication is facilitated by an application that needs to be downloaded and installed by the user. The installation files for the application reside on a server and can be accessed from this download web page 400. The login status 408 is independent of the connection status and indicates that the user is not logged into their account on the web site, but provides a link for them to click on in order to log in. Clicking on this link will also allow a user to register with the website if they have not previously done so. As is typical for online video sharing communities, users can play content without registering but are usually required to register with the website in order to contribute content or comment on others contributions. The page tab bar 410 indicates that we are currently viewing the Download web page on the web site. A description paragraph 412 informs the user as to the benefits of downloading and installing the application. A PC download button 414 and Mac download button 416 allows the user to select the appropriate application for the machine they are using. As a machine can have multiple browser types installed on it, an application for a PC for instance may support interfacing with Internet Explorer, Firefox and Safari depending on which browser the user happens to be using. When a user clicks either of these buttons, the browser will start downloading the application and oftentimes will automatically prompt the user for permission to install the application. The user's consent is necessary as a security measure.

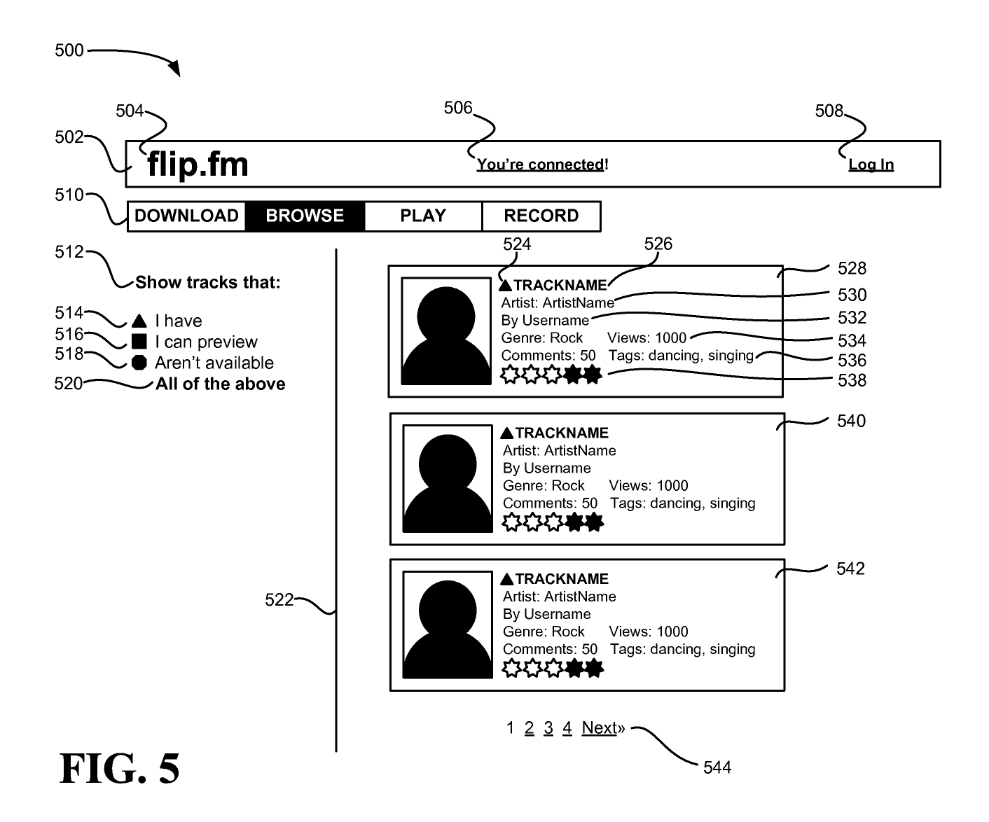

With reference now to FIG. 5 an exemplary browse web page 500 is shown that is used to browse videos that have been shared by users in an online community. The header section 502 contains the name of the web site 504, as well as the connection status 506 and the login status 508. The connection status 506 indicates that the user is “connected”, which means that there is at present a communication between the browse web page 500 and the music player on the user's local machine. The communication is facilitated by the downloaded application. The page tab bar 510 indicates that we are currently viewing the Browse web page on the web site. On the left side of the dividing line 522 is a filter description 512 above four filters that can be used to control the videos that are shown on the right side of the dividing line 522. The first filter 514 has a triangle next to it which indicates that it is a convention of the web site to put, as an availability symbol, a triangle next to any track name that the user has on their local machine. The downloaded application communicates with the music player which typically contains a listing of all music tracks available on the local machine. This listing is synchronized with a database that is in communication with the web servers. The web servers, therefore, are able to determine which tracks the local machine has at the time the browse web page 500 is constructed. If the first filter 514 is clicked then only videos that match tracks on the local machine are displayed to the right of the dividing line 522. The second filter 516 has a square next to it which indicates that it is a convention of the web site to put, as an availability symbol, a square next to any track name that the user does not have on their local machine but for which there is a preview available, usually through a third party service that sells licensed copies of the music track and provides a preview. In these cases the preview, which is typically a segment of the music track, can be downloaded to the local machine so that the user can view a segment of the video with the section of the music track which is publicly available as a preview. An alternate mechanism is to combine the preview track with the video content on the server and allow the client to view the segment of music video already synchronized to the audio content as it is downloaded from the server. The third filter 518 has a circle next to it which indicates that it is a convention of the web site to put, as an availability symbol, a circle next to any track name that the user does not have on the local machine and for which there is no preview available. The fourth filter 520 has no availability symbol next to it as it allows for all types of videos to be displayed to the right of the dividing line 522. To the right of the dividing line 522 is a listing of videos that meet the filter criteria to the left of the dividing line 522. There is a first video 528, second video 540 and third video 542. By way of example, the first video 528 has the associated music track name 528 to which this video can be synchronized. Adjacent to the music track name 528 is the availability symbol 524 which in this case is a triangle indicated that the music track is available on the local machine. The music track artist 530 is listed below, as well as the username 532 of the member that recorded or uploaded the video. The genre and views line 534 indicates the genre of the music track and the number of times the video has been viewed. The comments tags line 536 indicates the number of comments that have been posted by members relating to the video, and the tags associated with the video by the user that posted the video. The rating stars 538 indicates the average rating that was given to the video by members in the online community. At the bottom of the video listing is a conventional pagination control 544 which allows a user to move through the numerous pages of videos that are listed.

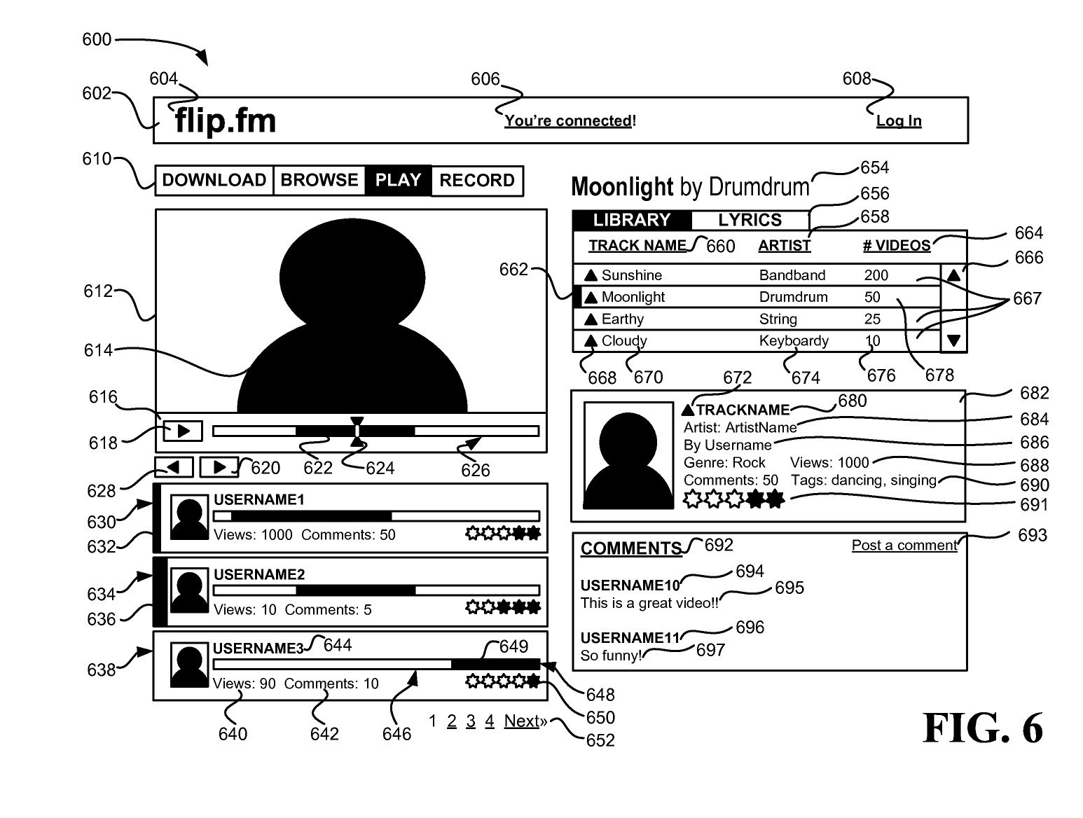

With reference now to FIG. 6 an exemplary play web page 600 is shown that is used to play videos that have been shared by users in an online community. While not all elements of the web page are necessary to display synchronized video content with a music track being played, this web page provides additional functionality to navigate through applicable music tracks and for the user to control the tracks that are playing in their music library. A video may even play on a different web site through code being embedded in a blog or suchlike. In this case only a portion of this exemplary play web page 600 needs to be included in the embedded control that is generated with HTML markup and javascript as in convention and known by those of skill in the art. Importantly, some unique identifying code needs to be present in the markup or url for the installed application to recognize when such an embedded control is present on a page. The header section 602 contains the name of the web site 604, as well as the connection status 606 and the login status 608. The connection status 606 indicates that the user is “connected”, which means that there is at present a communication between the play web page 600 and the music player on the user's local machine. The communication is facilitated by the downloaded application. The page tab bar 610 indicates that we are currently viewing the Play web page on the web site. Below the page tab bar 610 is the video player 612 which plays the video content. The video player 612 may also be maximized to take over the entire screen as is typical for such video players and functionality that is inherently present and can be exposed to the user through controls by engineers with skill in the art. Video players are usually embedded applications that are browser plugins or ActiveX control (for instance, Apple Quicktime, Flash or Silverlight). Whichever video player technology is used it is important that one can interface with the video player 612 through some form of application program interface (API) to control the playing of the video content 614 and be able to seek to precise frames in the video. Below the video player 612 is the video control panel 616 which has a play button 618, a music track timeline 626 and a scrub bar 624. The play button 618 is used to stop and start the video. When the video is playing the play button 618 changes its symbol to a square to indicate that the button will stop the video when it is pressed. The music track timeline 626 represents the time on the music track that is currently playing in the music player on the local machine. The scrub bar 624 can be dragged by the user through the use of a pointing device, like a mouse. When the user changes the position of the scrub bar 624, a script will update the play position of the music track being played by the music player. This is facilitated through messages that are given to the installed application. The installed application which is monitoring the current music track and the position where the current music track is currently playing will in turn relay back to the web page the current music track time and the script on the web page will update the position of the video content 614 that is playing in the video player 612. Since the video content 614 may be shorter than the length of the music track that is being played in the music player, the overlap region 622 is represented on the music track timeline 626. The overlap region 622 is the duration and position of the music track to which video content will perfectly synchronize, and therefore the only region of the music track which will allow the specific video content 614 to play. Below the video control panel 616 is a previous video button 628 and a next video button 620. When these buttons are pressed by the user, the current video being played will change to the next video that currently overlaps in time with the position that the music track is playing in the music player. All videos that match the current music track and current music artist 654 are listed below the previous video button 628 and next video button 620. When the listing is long, a pagination control 652 is displayed to help the user navigate through the relevant videos. The first video 630, second video 634 and third video 638 shown were all recorded by different members of the online community, and all had the same music track playing on their local machine at the time they recorded the video that is currently playing in the user's music player. The determination as to which tracks are the same is made by comparing metadata associated with the music tracks for substantial similarity. Each listed video has a username 644 listed, a timeline 648, the number of views 640, the number of comments 642 and the average rating 650. The timeline contains an overlap region 649 which is the duration and position of the music track to which video content will perfectly synchronize, and therefore the only region of the music track which will allow the specific video content 614 to play. When the position of the scrub bar 624 is horizontally in line with the overlap region 649 then a the music track is playing at a time when the video content can be synchronized with it and a representation is made with a thin black bar 632 along the left side of the video listing. The second video 634 is actively playing in the video player 612 and this is represented by a thick black line 636. If the user presses the next video button 620 at this time then there is no other video below the currently playing video that is currently applicable for the music track's current time so it will revert back to the top of the video listing to the first video 630. If the user presses the previous video button 628 it will also move to the first video 630 since it is the closest video higher up in the listing that is currently applicable for the music track's current time. If a video finishes playing and the music track continues to play, a script will look for the next applicable video in the listing and start playing that video. If there are no applicable videos to be played, then a message will appear in the video player 612 indicating that there are no videos available. Another way to change the video playing would be to click on the applicable video in the video listing. For instance, clicking on the first video 630 will start playing the video in the video player 612. This will only work if the video is currently applicable to the current position of the music track being played, as indicated by the thick black bar 632. Another time the video may change to the next applicable video is if the scrub bar 624 is moved by the user so that the music player is playing at a new place where the current video playing in the music player 612 is no longer applicable. Below the current music track and current music artist 654 is the library tab bar 656 which indicates that the region immediately below and contiguous with the library tab bar 656 is currently displaying the library of tracks that exists on the local machine. This list is generated by the downloaded application interrogating the local music player through its application programming interface as to the tracks that exist on the local machine and then uploading a copy of the track listing to the web servers and databases that serve the web site content. The library can therefore be automatically loaded when the play web page 600 loads or after it loads through an asynchronous call (e.g. AJAX call) back to the web servers once the page has loaded. There is a track name column heading 660, artist name column heading 658 and number of videos column heading 664. As per convention on the web site there is a symbol 668 adjacent to every track name 670 indicating the accessibility status of each music track. This listing will typically contain only those tracks present on the local machine but additional functionality may allow for preview tracks to also be included in this listing, in which case those track names will have a different accessibility symbol next to them. There is one active track listing 678 as indicated by the black line 662 on the left side of the row. The active status means that the track is currently playing in the local music player and this is also indicated by the current music track and current music artist 654 on the page. The inactive rows 667 are clickable and will cause the relevant track to start playing in the local music player when clicked on with a pointer device by the user. In this embodiment the click action will implement javascript to place a flag in a hidden field on the web page. The downloaded application which frequently monitors the play web page 600 will evaluate the flags that have been placed and implement the appropriate actions. In this case the downloaded application will cause the music player to start playing the required track by using the music player's application programming interface. While it is possible to control the music player in this manner through the play web page 600 it is also possible for the user to control the music player directly on the local machine. When the user navigates back to the play web page 600 then the information regarding the music track that is currently playing will be relayed to the play web page 600 from the installed application. The installed application detects that the browser is on a page that requires the current music data and then sends the data by calling javascript functions or by populating hidden input fields that exist on the play web page 600. These actions trigger the play web page 600 to update various sections of the play web page 600 so that they reflect the appropriate data, and will start playing a video in the video player 612 that relates to the track playing in the music player. There is also a scroll bar 665 which is used to navigate through the rows of tracks when many exist. The selected video region 682 contains details of the selected video on the play web page 600. This is usually the video that is playing in the video player 612 but may persist after the video plays if no other video starts playing. It may also persist if the user is entering a comment or rating, even if another video starts playing during this time. The play web page 600 may provide mechanisms for the user to select a video without causing it to play. This is useful if the user wishes to view the associated comments before deciding whether to play the video or not. The selected video region 682 has a music track name 680 with the availability symbol 672 adjacent to it. In this case the availability symbol 672 is a triangle which indicates that the music track is available on the local machine. The music track artist 684 is listed below, as well as the username 686 of the member that recorded or uploaded the video. The genre and views line 688 indicates the genre of the music track and the number of times the video has been viewed. The comments tags line 690 indicates the number of comments that have been posted by members relating to the video, and the tags associated with the video by the user that posted the video. The rating stars 691 indicate the average rating that was given to the video by members in the online community. Below the selected video region 682 is the comments title 692 with comments listed below it. The first comment listing has a username 694 with the comment text 695 and the second comment listing has a username 696 with the comment text 697. The user can leave a comment on a video by clicking the post a comment link 693. Given that the user of this play web page 600 is not logged in, as indicated by the login status 408, they will be prompted to log in when they click this post a comment link 693. Of note is that the local machine is identified independent of the user by the web site, so that a user can log in on different local machines and play the music on the local machine that they are using with associated video content. Furthermore, more than one user may log in to the website using the same local machine.

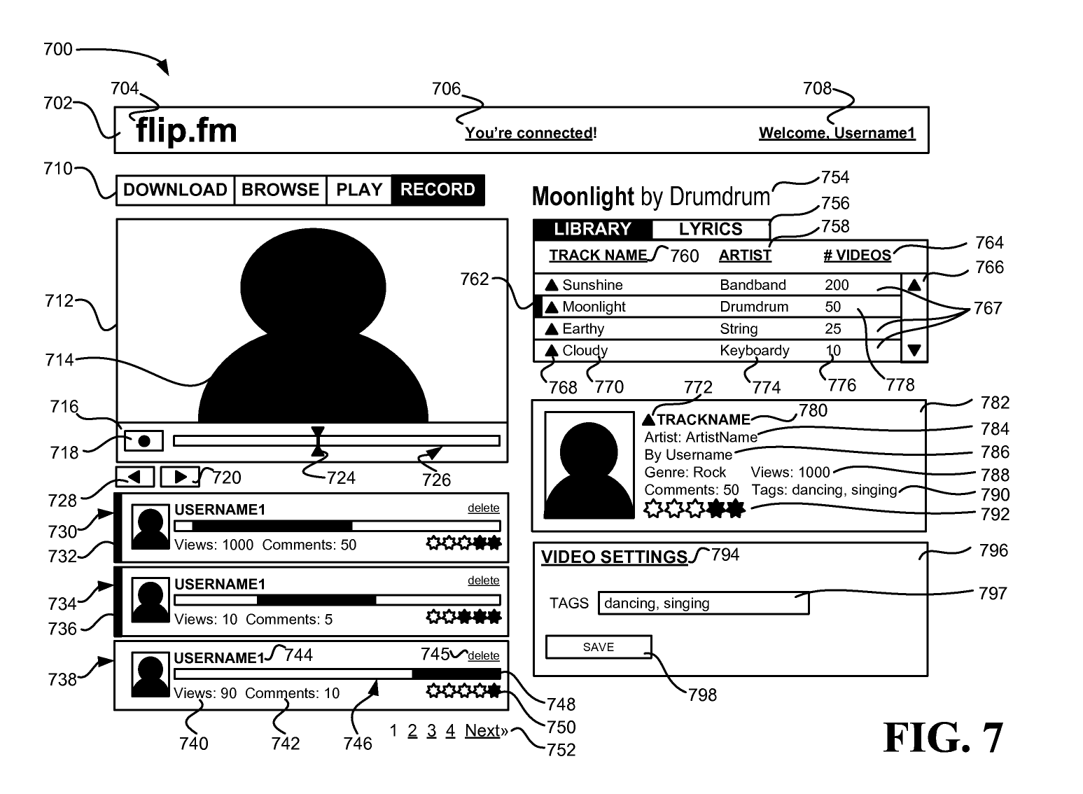

With reference now to FIG. 7 an exemplary record web page 700 is shown that is used to record videos in order to share them with the online community. While not all elements of the web page are necessary to record synchronized video content with a music track being played, this web page provides additional functionality to navigate through applicable music tracks and for the user to control the tracks that are playing in their music library. A video may even be recorded on a different web site through code being embedded in a blog or suchlike. In this case only a portion of this exemplary record web page 700 needs to be included in the embedded control that is generated with HTML markup and javascript as in convention and known by those of skill in the art. Importantly, some unique identifying code needs to be present in the markup or url for the installed application to recognize when such an embedded control is present on a page. The header section 702 contains the name of the web site 704, as well as the connection status 706 and the login status 708. The connection status 706 indicates that the user is “connected”, which means that there is at present a communication between the play web page 700 and the music player on the user's local machine. The communication is facilitated by the downloaded application. The login status 708 shows that Usename1 is logged into the web site. It is necessary to be registered and logged in to the web site in order to record videos. The page tab bar 710 indicates that we are currently viewing the Record web page on the web site. Below the page tab bar 710 is the video player 712 which plays the video content. While recording the video player 712 will show the content that is being recorded, and once recorded the user has the ability to play back the recorded content. This play back mode operates in a substantially similar way to the way video is played back on the play web page 600 of FIG. 6. The video player 712 may also be maximized to take over the entire screen as is typical for such video players and functionality that is inherently present and can be exposed to the user through controls by engineers with skill in the art. Video players are usually embedded applications that are browser plugins or ActiveX control (for instance, Apple Quicktime, Flash or Silverlight). Whichever video player technology is used it is important that one can interface with the video player 712 through some form of application program interface (API) to control the playing of the video content 714 and be able to seek to precise frames in the video. Below the video player 712 is the video control panel 716 which has a record button 718, a music track timeline 726 and a scrub bar 724. The record button 718 is used to stop and start the video recording. When the video is recording the record button 618 changes its symbol to a square to indicate that the button will stop the video recording when it is pressed. The music track timeline 726 represents the time on the music track that is currently playing in the music player on the local machine. The scrub bar 724 can be dragged by the user through the use of a pointing device, like a mouse. When the user changes the position of the scrub bar 724, a script will update the play position of the music track being played by the music player. This is facilitated through messages that are given to the installed application. The installed application which is monitoring the current music track and the position where the current music track is currently playing will in turn relay back to the web page the current music track time and the script on the web page will update the position of the video content 714 that is playing in the video player 712. When video is recorded, then the position of the scrub bar 724 is noted as the respective start and end times of the recording. These data points are submitted to the database of the web site and are used to generate the listing of relevant videos for a particular time of a music track. Other data that is submitted to the database during recording, along with the actual video content, is data about the music track that is playing. This data is transferred from the installed application to the record web page 700. The recorded video content is captured from an attached video recording device, like a USB web camera, or similar. It is possible to access various registered video recording devices through installed applications that are often preinstalled by users on their local machines. One application that is typically used for this purpose by those of skill in the art is Adobe Flash Player as it is widely disseminated at present on users' local machines. When recording video content from such installed embedded components the video is encoded and streamed to a remote recording server. The metadata associated with the video content as described above (including the music track information and the video start time) may be transferred to the web site servers and related database via a separate connection and transmission. In this embodiment the format of the video when it is recorded and saved on the remote server is not suitable for playing back the video in a tightly controlled manner. A tightly controlled manner is necessary to seek to the precise frame of the video necessary to substantially synchronize the video to the track that is being played by the music player. Therefore, in this embodiment, when the video has finished recording, by the user clicking the record button 718 (that has changed to a stop button representation), or by the user moving the scrub bar 724, or by the track changing in the local music player, then the saved video content on the remote recording video server will get transcoded into a video format that is conducive to being tightly controlled during playback. The framerate and number of keyframes may also be altered in the new format to optimize the playback of the video in this tightly controlled manner. Below the video control panel 716 is a previous video button 728 and a next video button 720. When these buttons are pressed by the user, the current video being played will change to the next video that currently overlaps in time with the position that the music track is playing in the music player. All videos that match the current music track and current music artist 754 are listed below the previous video button 728 and next video button 720. When the listing is long, a pagination control 752 is displayed to help the user navigate through the relevant videos. The first video 730, second video 734 and third video 738 shown were all recorded by the current user, and all had the same music track playing on their local machine at the time they recorded the video that is currently playing in the user's music player. The determination as to which tracks are the same is made by comparing metadata associated with the music tracks for substantial similarity. Each listed video has the current user's username 744 listed, a timeline 748, the number of views 740, the number of comments 742 and the average rating 750. Since only the videos that the logged in user has recorded are displayed on the record video page 700, there is a delete link 745 in each video listing. When the user clicks the delete video link 745 that video is deleted from view and flagged as deleted in the database so that it will not be shown to other users. The timeline contains an overlap region 749 which is the duration and position of the music track to which video content will perfectly synchronize, and therefore the only region of the music track which will allow the specific video content 714 to play. When the position of the scrub bar 724 is horizontally in line with the overlap region 749 then a the music track is playing at a time when the video content can be synchronized with it and a representation is made with a thin black bar 732 along the left side of the video listing. The second video 734 is actively playing in the video player 712 and this is represented by a thick black line 736. If the user presses the next video button 720 at this time then there is no other video below the currently playing video that is currently applicable for the music track's current time so it will revert back to the top of the video listing to the first video 730. If the user presses the previous video button 728 it will also move to the first video 730 since it is the closest video higher up in the listing that is currently applicable for the music track's current time. If a video finishes playing and the music track continues to play, a script will look for the next applicable video in the listing and start playing that video. If there are no applicable videos to be played, then a message will appear in the video player 712 indicating that there are no videos available. Another way to change the video playing would be to click on the applicable video in the video listing. For instance, clicking on the first video 730 will start playing the video in the video player 712. This will only work if the video is currently applicable to the current position of the music track being played, as indicated by the thick black bar 732. Another time the video may change to the next applicable video is if the scrub bar 724 is moved by the user so that the music player is playing at a new place where the current video playing in the music player 712 is no longer applicable. Below the current music track and current music artist 754 is the library tab bar 756 which indicates that the region immediately below and contiguous with the library tab bar 756 is currently displaying the library of tracks that exists on the local machine. This list is generated by the downloaded application interrogating the local music player through its application programming interface as to the tracks that exist on the local machine and then uploading a copy of the track listing to the web servers and databases that serve the web site content. The library can therefore be automatically loaded when the record web page 700 loads or after it loads through an asynchronous call (e.g. AJAX call) back to the web servers once the page has loaded. There is a track name column heading 760, artist name column heading 758 and number of videos column heading 764. As per convention on the web site there is a symbol 768 adjacent to every track name 770 indicating the accessibility status of each music track. There is one active track listing 778 as indicated by the black line 762 on the left side of the row. The active status means that the track is currently playing in the local music player and this is also indicated by the current music track and current music artist 754 on the page. The inactive rows 767 are clickable and will cause the relevant track to start playing in the local music player when clicked on with a pointer device by the user. In this embodiment the click action will implement javascript to place a flag in a hidden field on the web page. The downloaded application which frequently monitors the record web page 700 will evaluate the flags that have been placed and implement the appropriate actions. In this case the installed application will cause the music player to start playing the required track by using the music player's application programming interface. There is also a scroll bar 765 which is used to navigate through the rows of tracks when many exist. The selected video region 782 contains details of the selected video on the record web page 700. This is usually the video that is playing in the video player 712 but may persist after the video plays if no other video starts playing. It may also persist if the user is entering a comment or rating, even if another video starts playing during this time. The record web page 700 may provide mechanisms for the user to select a video without causing it to play. This is useful if the user wishes to view the associated comments before deciding whether to play the video or not. The selected video region 782 has a music track name 780 with the availability symbol 772 adjacent to it. In this case the availability symbol 772 is a triangle which indicates that the music track is available on the local machine. The music track artist 784 is listed below, as well as the username 786 of the member that recorded or uploaded the video. The genre and views line 788 indicates the genre of the music track and the number of times the video has been viewed. The comments tags line 790 indicates the number of comments that have been posted by members relating to the video, and the tags associated with the video by the user that posted the video. The rating stars 792 indicate the average rating that was given to the video by members in the online community. Below the selected video region 782 is the video settings region 796 with it the video settings title 794, a tags editing field 797 and a save button 798 to commit changes to the tags.

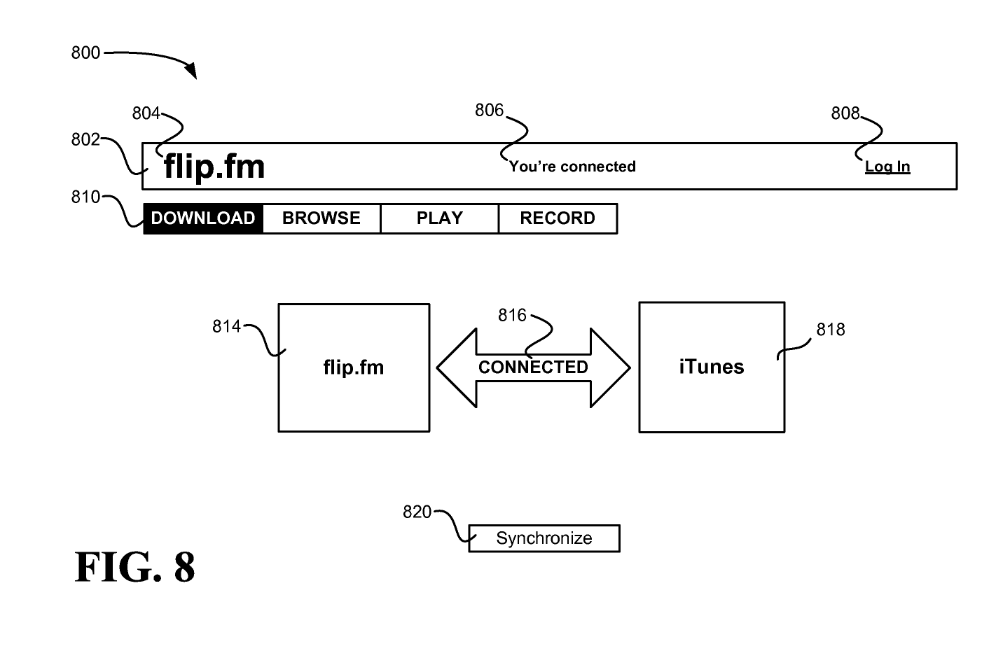

With reference now to FIG. 8 an exemplary connection web page 800 is displayed that is used to display the connection status with a music player. The header section 802 contains the name of the web site 804, as well as the connection status 806 and the login status 808. The connection status 806 indicates that the user is “connected”, which means that there is at present a communication between the connection web page 800 and the music player on the user's local machine. The communication is facilitated by the downloaded application. The login status 808 shows that the user is not logged in and provides a link to allow the user to log in with login credentials that they chose when they registered as a user of the web site. The page tab bar 810 indicates that we are currently viewing the connection web page on the web site. Below the page tab bar 810 a schematic diagram with the web site block 814 and the music player block 818 on either side of a connection status arrow 816. When there is a connection between the web page and the music player then the connection status arrow 816 is present but is not present when there is no connection. Also, when connected, a synchronize button 820 is displayed that allows the user to initiate a synchronization of the names of music tracks present on the local machine with the machine's record in the web site database. When a person adds or removes tracks from their local machine then it is necessary to synchronize the tracks with that on the database so that availability symbols are appropriate for the track names displayed on the web site. This synchronization function may also be implemented automatically in the background without the user initiating it, or being aware of it. The actual music tracks are not uploaded to the web servers or database, but only the track names and track artists and other identifying metadata of the tracks that can be used to match them to records of other tracks from other machines and from third parties on the remote web servers. In order to synchronize the video with the music track it may be necessary for the video to contain some graphical form of timing information. One way to accomplish this would be for the video to film the screen of a music player while it is playing the music track thereby acting as a type of clapboard. A clapboard is used to produce professional music videos by providing a mechanism for the person editing the video content to know where the audio track was playing when the video content was recorded. By capturing the screen of the music player at some point in the recording, it is possible to either automatically or manually deduce the time at a specific frame and thereby allow the video content to be locked to a specific region of the music track.

The invention is not limited to the preferred embodiment and provides for ways in which a user can upload video content captured independent of the machine playing the music and then synchronize the video to the music track once it has been uploaded. Or alternatively synchronize it once it has been loaded on a local machine containing the music track and then upload the video content with the associated metadata containing information that can be used to synchronize the video with the music at a later time.

An interface may be provided by a local application or a web application to splice numerous clips together while allowing them to be easily synchronized to a music track. In the case where the video content exists on the server and an online interface allows such editing, the installed application will serve as the link between the online manipulation of the video content and the playing of the music track locally so that the user can appreciate how the video will ultimately be experienced by another user.

In a further aspect of the invention, it is conceived that when bandwidth allows for very low latency connections on a peer to peer basis or through a central server, that multiple user playing the same track on different machines in different locations may be able to share video content in real time with each other. If the latency for sharing such video content is below a threshold value discernable by a human (e.g. 300 ms) then they can feel as though they are singing, dancing, or generally experiencing the music at the same time. In this case the installed application would control the playback of the music player in order to facilitate this simultaneous listening. The session may or may not be recorded on the central servers for later playback by users listening to the same music track.

Another aspect of the invention allows for prerecorded video content to be played back at a live venue in a concert setting when a band may be playing a music track at a predetermined and controlled tempo so that the video can be synchronized to their performance.

I claim:

1. A system to facilitate authoring and sharing of music videos, comprising:
a first client machine which transmits video without its corresponding audio to at least one server;
a second client machine that displays said transmitted video while synchronized to corresponding audio that is present on said second client machine.
